(19) United States
(12) Patent Application Publication
(10) Pub. No.: US 2017/0274832 A1
(43) Pub. Date: Sep. 28, 2017

(54) WINDSHIELD INCLUDING VEHICLE-MOUNTED RADAR

(71) Applicant: NIDEC ELESYS CORPORATION, Kawasaki-shi (JP)

(72) Inventor: Akira ABE, Kawasaki-shi (JP)

(21) Appl. No.: 15/466,928

(22) Filed: Mar. 23, 2017

(30) Foreign Application Priority Data
Mar. 24, 2016 (JP) 2016-060114
Jun. 21, 2016 (JP) 2016-122682

(51) Int. Cl. B60R 11/02; G01S 7/02; G01S 13/93; B60J 1/02; B60R 1/04

(52) U.S. Cl. CPC B60R 11/02; B60J 1/02; B60R 1/04; G01S 13/931; G01S 7/024; B60R 2011/0026

(57) ABSTRACT

A windshield includes a radar that detects an object around the radar with transmitted and received radio waves in a millimeter band and a radar window on which at least a portion of the radio waves is incident. The windshield includes a windshield main body including a single glass layer or at least one glass layer on which a resin layer is laminated. Both of the windshield main body and the radar window are plate-shaped. An area of the radar window is smaller than an area of the windshield main body. A dielectric constant of the radar window is smaller than a dielectric constant of the glass layer. At least a portion of a side surface connecting an outer surface and an inner surface of the radar window is in contact with a side surface connecting an outer surface and an inner surface of the windshield main body.

### CROSS REFERENCE TO RELATED APPLICATIONS

This application claims the benefit of priority to Japanese Patent Application No. 2016-060114 filed on Mar. 24, 2016 and Japanese Patent Application No. 2016-122682 filed on Jun. 21, 2016. The entire contents of these applications are hereby incorporated herein by reference.

### BACKGROUND OF THE INVENTION

1. Field of the Invention

The present invention relates to a windshield including a vehicle-mounted radar that transmits and receives radio waves in a millimeter band.

2. Description of the Related Art

Some automobiles are equipped with a radar for radiating a radio wave and receives a reflected wave in a front nose portion or near a rear gate. However, these portions are readily deformed and broken when such an automobile collides with another vehicle or object even if the collision is insignificant. The radar is likely to be broken as well if it is attached to such portions. The radar is a device necessary for securing safety of the automobile, and it is therefore undesirable that the radar stops functioning in a minor collision. The problem is still more serious if automatic driving is put to practical use.

If a radar device is mounted in a vehicle interior, such a situation less likely occurs. However, the radar device has to transmit and receive radio waves through a windshield including glass. In this case, it is hard to avoid occurrence of reflection and absorption of the radio waves in the glass. A detection ability of the radar is limited.

Under such circumstances, European Patent No. 888646 discloses a method in which, when an antenna for communication is set in a vehicle interior, a dielectric intermediate member is disposed between glass and a radiation surface of the antenna in order to suppress reflection of radio waves by the glass. In European Patent No. 888646, an electrically effective interval between the glass and the antenna is adjusted to a half wavelength or a length multiplied by an odd number thereof.

When the radio waves in the millimeter band are used as radar waves, strong reflection occurs on the surface of the windshield including the glass. Even when the dielectric intermediate member is disposed between the glass and the radiation surface of the antenna as in European Patent No. 888646, strong reflection occurs on the surface of the intermediate member. Usually, since the windshield is inclined with respect to the radiation surface of the antenna, the interval between the glass and the antenna cannot be adjusted to be constant at the desired length. Therefore, there is a demand for a novel method for reducing a loss of the radar waves that pass through the windshield.

### SUMMARY OF THE INVENTION

Preferred embodiments of the present invention have been devised in view of the above-described problems and reduce loss of radar waves that pass through a windshield.

A preferred embodiment of the present invention provides a windshield including a radar that detects an object around the radar with transmitted and received radio waves in a millimeter band and a radar window on which at least a portion of the radio waves is made incident. The windshield includes a windshield main body including a single glass layer or at least one glass layer on which a resin layer is laminated. Both of the windshield main body and the radar window preferably are plate-shaped. An area of the radar window is smaller than an area of the windshield main body. A dielectric constant of the radar window is smaller than a dielectric constant of the glass layer. At least a portion of a side surface connecting an outer surface and an inner surface of the radar window is in contact with a side surface connecting an outer surface and an inner surface of the windshield main body.

According to preferred embodiments of the present invention, it is possible to reduce a loss of radar waves that pass through the windshield.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view showing a vehicle in a simplified form.

FIG. 2A is a front view of the vehicle.

FIG. 2B is a sectional view of a windshield.

FIG. 3 is a block diagram schematically showing the configuration of a radar device.

FIG. 4 is a view of an antenna viewed from a first direction.

FIG. 5A is a view of an antenna that uses a radio wave of a vertically polarized wave as viewed from a first direction.

FIG. 5B is a sectional view of an antenna that uses the radio wave of the vertically polarized wave as viewed from a second direction.

FIG. 5C is a sectional view of an antenna that uses the radio wave of the vertically polarized wave as viewed from a third direction.

FIG. 6A is a view of an antenna that uses a radio wave of a horizontally polarized wave as viewed from the first direction.

FIG. 6B is a sectional view of an antenna that uses the radio wave of the horizontally polarized wave as viewed from the second direction.

FIG. 6C is a sectional view of an antenna that uses the radio wave of the horizontally polarized wave as viewed from the third direction.

FIG. 7 is a diagram showing a relationship between the reflectance of the windshield and a tilt angle τ of the windshield at the time when the radio waves of the vertically polarized wave and the horizontally polarized wave are used.

FIG. 8 is a diagram showing a relationship between the reflectance of the windshield and the tilt angle τ of the windshield at the time when the radio wave of the horizontally polarized wave is used.

FIG. 9A is a view of a windshield as viewed from the first direction.

FIG. 9B is a sectional view of a windshield as viewed from the second direction.

FIG. 9C is a view of a windshield as viewed from the first direction.

FIG. 10A is a spatial power distribution in a YZ plane including a radiation center axis in a third direction position Vt.

FIG. 10B is a spatial power distribution in an XY plane including a radiation center axis in a second direction position Ut.

FIG. 11A is a sectional view of a windshield of a modification according to a preferred embodiment of the present invention as viewed from the second direction.

FIG. 11B is a view of a vehicle-mounted radar shown in FIG. 11A as viewed from an aperture side of the antenna.

FIG. 11C is a sectional view taken along A-A of the vehicle-mounted radar shown in FIG. 11B.

FIG. 12 is a diagram showing a modification according to a preferred embodiment of the present invention.

FIG. 13 is a diagram showing a modification according to a preferred embodiment of the present invention.

FIG. 14 is a diagram showing a reception wave arriving at a reception antenna.

FIG. 15 is a diagram showing a state in which a radio wave is incident on a general windshield.

### DETAILED DESCRIPTION OF THE PREFERRED EMBODIMENTS

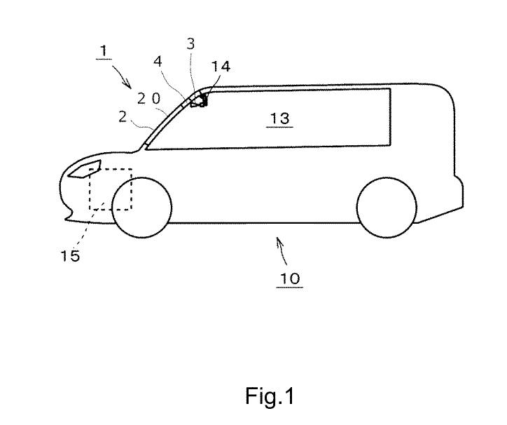

FIG. 1 is a side view showing, in a simplified form, a vehicle 1 mounted with a windshield 2 according to a preferred embodiment of the present invention. The vehicle 1 is a passenger car. The vehicle 1 includes a driving mechanism 15 that moves a vehicle body 10. The driving mechanism 15 includes an engine, a steering mechanism, a power transmission mechanism, wheels, and the like. The windshield 2 includes a vehicle-mounted radar 3.

The windshield 2 is fixed to the vehicle body 10 and located between a vehicle interior 13 and the outside. The windshield 2 includes a windshield main body 20 and a radar window 4. When the windshield 2 is attached to a front side, which is a traveling direction side of the vehicle 1, the vehicle-mounted radar 3 is attached to a rear view mirror 14. The vehicle-mounted radar 3 is disposed between the radar window 4 and the rear view mirror 14. As another attachment form, the vehicle-mounted radar 3 is on the inner surface of the windshield 2 directly or indirectly via a member for attachment such as a bracket. The vehicle-mounted radar 3 can also be attached to the ceiling.

When the windshield 2 is attached to a rear side, which is the opposite side of the traveling direction side of the vehicle 1, the vehicle-mounted radar 3 is fixed to the inner surface of the windshield 2 directly or indirectly via a member for attachment such as a bracket. The vehicle-mounted radar 3 can also be attached to the ceiling. In the figure, as the windshield 2, only the windshield attached to the front side of the vehicle 1 is shown. However, the windshield 2 in this specification also includes a windshield attached to the rear side.

The vehicle-mounted radar 3 is used for collision avoidance, driving assistance, automatic driving, and the like. The vehicle-mounted radar 3 is located in the vehicle interior 13. The vehicle interior 13 does not need to be a space completely divided from the outside. For example, the ceiling may be opened.

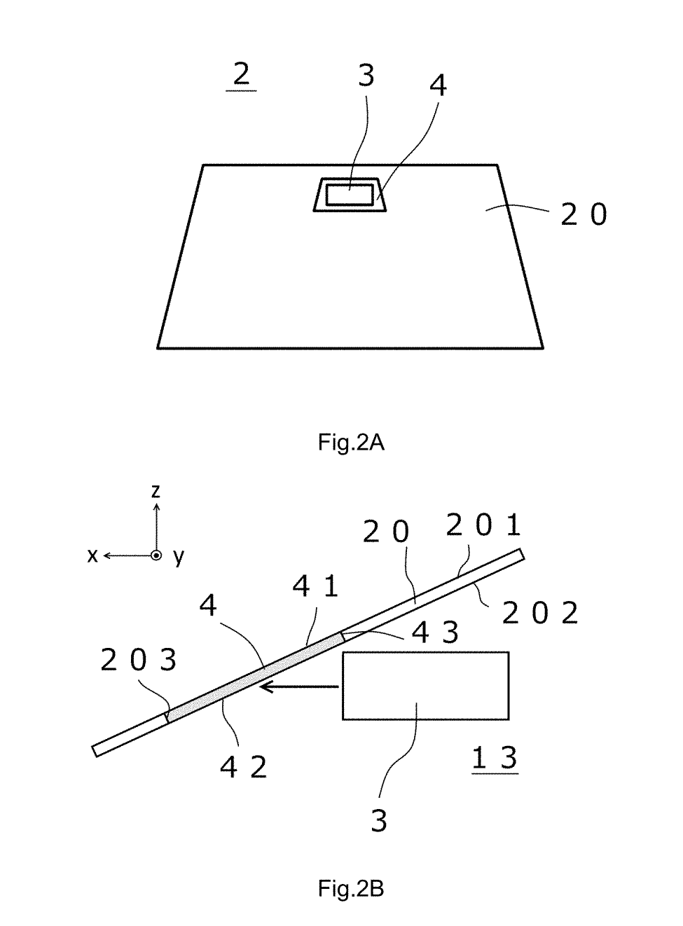

FIG. 2A is a front view of the vehicle 1. For simplification, only the windshield 2 is shown. FIG. 2B is a sectional view of the windshield 2. The windshield 2 includes the windshield main body 20 and the radar window 4, which respectively have plate shapes. The area of the radar window 4 is smaller than the area of the windshield main body 20. The radar window 4 is located above the windshield 2 and is disposed on the inside of the windshield main body 20. An arrow indicates a traveling direction of a radio wave. The radio wave is transmitted in a first direction (an x direction) by the vehicle-mounted radar 3 and then delivered to the outside through the radar window 4, made incident on the vehicle interior 13 from the outside through the radar window 4, and received by the vehicle-mounted radar 3.

When the windshield 2 is attached to the front side, the windshield main body 20 is shatterproof glass in which a resin layer is laminated between two glass layers. The resin layer is desirably made of polyvinyl butyrate (PVB). When the windshield 2 is attached to the rear side, the windshield main body 20 made of a single glass layer can be adopted. Irrespective of on which of the front side and the rear side the windshield 2 is attached, the radar window 4 is made of resin. As the resin forming the radar window, polycarbonate can be used. However, the resin is not limited to polycarbonate.

The windshield main body 20 includes an outer surface 201 of the windshield main body 20 facing the vehicle exterior, an inner surface 202 of the windshield 2 facing the vehicle interior, and side surfaces 203 of the windshield main body 20 that connect the outer surface 201 of the windshield main body and the inner surface 202 of the windshield 2. The radar window 4 includes an outer surface 41 of the radar window 4 facing the vehicle exterior, an inner surface 42 of the radar window 4 facing the vehicle interior, and side surfaces 43 of the radar window 4 that connect the outer surface 41 of the radar window 4 and the inner surface 42 of the radar window 4. The side surfaces 203 of the windshield main body 20 and the side surfaces 43 of the radar window 4 are in contact with each other. The outer surface 201 of the windshield main body 20 and the outer surface 41 of the radar window 4 form a one continuous surface. Similarly, the inner surface 202 of the windshield 2 and the inner surface 42 of the radar window 4 form a one continuous surface. Forming the one continuous surface means that, when the surface of the windshield main body is imaginarily extended, the extended surface substantially coincides with the surface of the radar widow. Even if a recess such as a groove is present in the boundary between the windshield main body and the radar window, if the surface of the windshield main body and the surface of the radar window substantially coincide with each other when the surface of the windshield main body is imaginarily extended, in this specification, it is defined that the surfaces form a one continuous surface.

The side surfaces 203 of the windshield main body 20 and the side surfaces 43 of the radar window 4 may be in contact with each other via an adhesive or the like. The inner surface and the outer surface of the windshield main body and the inner surface and the outer surface of the radar window do not always have to be continuous. Only the inner surfaces or the outer surfaces may be continuous or both of the inner surfaces and the outer surfaces do not have to be continuous.

The windshield main body 20 includes an upper edge and a lower edge extending in the lateral direction and respectively disposed in the up-down direction perpendicular to the lateral direction and a right edge and a left edge extending in the up-down direction. The lower edge is longer than the upper edge. The radar window 4 has a shape increasing in width from the upper edge toward the lower edge of the windshield main body 20. In the present preferred embodiment, both of the external shape of the windshield main body 20 and the external shape of the radar window 4 are trapezoidal shapes.

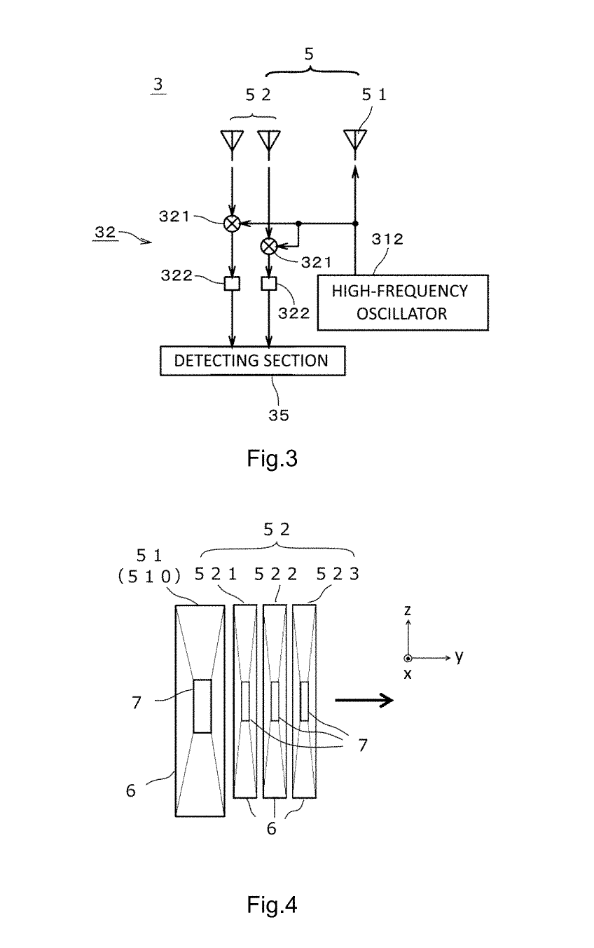

FIG. 3 is a block diagram schematically showing the configuration of the vehicle-mounted radar 3. The vehicle-mounted radar 3 includes an antenna 5. The antenna 5 further includes a transmission antenna 51 and a reception antenna 52. The transmission antenna 51 radiates a radio wave in a millimeter band having directivity. The reception antenna 52 receives a reflected wave originated from the radiated radio wave. Details of the antenna 5 are explained below.

The vehicle-mounted radar 3 further includes a high-frequency oscillator 312, a receiver 32, and a detecting section 35. The receiver 32 includes mixers 321 and A/D converters 322. The transmission antenna 51 is connected to the high-frequency oscillator 312. High-frequency power is output to the transmission antenna 51 by the high-frequency oscillator 312. Consequently, a transmitted wave is delivered from the transmission antenna 51.

The reception antenna 52 is connected to the mixers 321 and the A/D converters 322 in order. The A/D converters 322 are connected to the detecting section 35. The reception antenna 52 receives a reflected wave obtained when a transmission wave is reflected on a target object on the outside. A signal of a radio wave received by the reception antenna 52 is input to the mixers 321. A signal from the high-frequency oscillator 312 is also input to the mixers 321. Both of the signals are combined, whereby a beat signal indicating a difference between frequencies of the transmission wave and the reflected wave is obtained. The beat signal is converted into a digital signal in the A/D converters 322 and output to the detecting section 35 as a reception signal. The detecting section 35 performs Fourier transform of the beat signal and further performs arithmetic processing to calculate a position, speed, and the like of the target object.

### Regarding an Arriving Wave

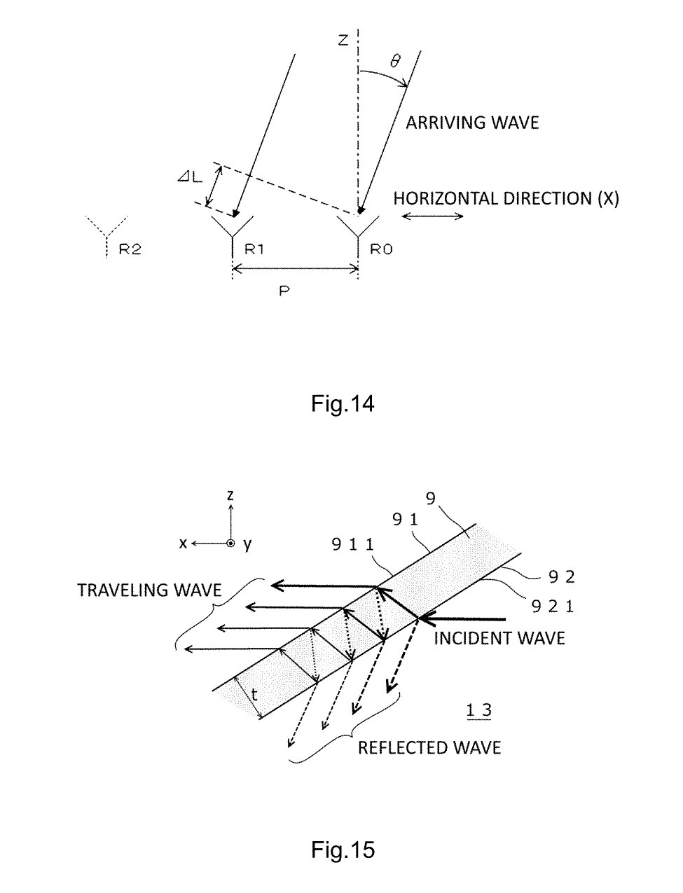

A method of specifying an angle of arrival of the target object in the reception antenna 52 is explained. FIG. 14 shows a reception wave arriving at the reception antenna. The reception antenna includes a plurality of reception antenna elements R0, R1, R2, . . . . The plurality of reception antenna elements are disposed at an equal interval P in the horizontal direction. When a reception wave arrives from an angle of arrival θ, a propagation path length difference ΔL occurs in the reception antenna elements adjacent to each other. A phase difference Δφ occurs in the reception wave.

ΔL=P·sin θ (Expression 1)

Δφ=k·ΔL+2iπ (Expression 2)

where, i represents an integer (0, ±1, . . . ) and k represents a wave number (=2π/λ).

From Equation 2, a detection value Θ of an angle of arrival is calculated.

Θ=sin−1{Δφ/(kP)} (Expression 3)

If the magnitude of Δφ is smaller than π(180°), Θ and θ coincide with each other and a direction can be specified.

When an angle of arrival at which Δφ=π is represented as χ, Expression 4 holds.

χ=sin−1{λ/(2P)} (Expression 4)

If θ is smaller than χ, Θ=θ. However, when θ slightly exceeds χ (θ=χ+δ), Θ is calculated as Θ≈−δ and the left and the right are reversed. Therefore, the angle of arrival is erroneously detected. Therefore, in order to prevent the angle of arrival from being erroneously detected, when an azimuth angle range to be monitored is represented as Ω, Expression 5 is a necessary condition for the interval P of the reception antenna elements.

P<λ/(2·sin Ω) (Expression 5)

Under a condition represented by Expression 6 below, a detection value for an arriving wave in a region outside of an angular field of view is |Θ|>Ω. That is, the angle of arrival does not appear in the azimuth angle range and erroneous detection does not occur.

P<λ/(1+sin Ω) (Expression 6)

For a plurality of arriving waves, the reception antenna elements are increased according to the number of the arriving waves to detect a plurality of angles of arrival. However, a condition of the reception interval P with respect to the azimuth angle range Ω to be monitored is the same.

A principle is explained regarding attenuation of a radio wave by a glass layer is explained. FIG. 15 is a diagram showing a state in which a radio wave is made incident on a general windshield 9. The windshield 9 is formed by a single glass layer and includes an outer surface 91 of the windshield 9 and an inner surface 92 of the windshield 9. In an incident wave transmitted in the vehicle interior 13, on a boundary surface 921 between the inner surface 92 of the windshield 9 and the air, a traveling wave to the glass layer and a reflected wave reflected on the boundary surface 921 occur. On a boundary surface 911 between the outer surface 91 of the windshield 9 and the air, in the incident wave traveling to the glass layer, a traveling wave to the vehicle exterior and a reflected wave reflected on the boundary surface 911 and returning to the glass layer occur. Further, the radio wave repeats multiple reflection on the boundary surface 911 and the boundary surface 921. An added-up wave of the traveling waves is a transmission wave transmitted to the vehicle exterior. Therefore, a larger loss occurs in the transmission wave as a reflection component is larger.

Reflection on the glass surface of the radio wave in the millimeter band is large compared with the reflection of radio waves in the other frequency bands. That is, reflectance, which is a ratio of the magnitude of the reflected wave to the magnitude of the incident wave, is large compared with the reflectance of the radio waves in the other frequency bands. Therefore, a large loss occurs in a radar wave. The reflectance depends on a dielectric constant of an object. The reflectance is small when the dielectric constant is small. In the present preferred embodiment, by using a radar window made of resin having a dielectric constant lower than the dielectric constant of the glass layer, it is possible to reduce the reflectance and suppress the loss of the radar wave.

Note that, when the windshield 2 is attached to the front side, the windshield 2 (the windshield main body 20) is usually shatterproof glass of three layers in which a resin layer is laminated between two glass layers. In this case, a large loss occurs in the radar wave as in the single glass layer.

Details of the structure of the antenna 5 are explained. FIG. 4 shows the antenna 5 as viewed from a first direction. As explained above, the antenna 5 includes the transmission antenna 51 and the reception antenna 52. The transmission antenna 51 and the reception antenna 52 respectively include one transmission horn 510 and three reception horns 521, 522, and 523. The horns have a shape, the sectional area of which gradually increases from bases 7 to aperture 6. The transmission horn 510 and the reception horns 521, 522, and 523 are disposed in this order at an interval in a second direction (a y direction) perpendicular to the first direction. The respective horns have a rectangular shape extending toward the second direction and a third direction (a z direction) perpendicular to a surface formed by the first direction and the second direction. The reception horns 521, 522, and 523 have the same shape. The long side of the transmission horn 510 is longer than the long sides of the reception horns 521, 522, and 523. The short side of the transmission horn 510 is longer than the short sides of the reception horns 521, 522, and 523.

As radio waves used in the vehicle-mounted radar 3, a vertically polarized wave or a horizontally polarized wave is conceivable. The radio wave of the vertically polarized wave is a radio wave, the electric field of which is perpendicular to a traveling direction of the radio wave. The radio wave of the horizontally polarized wave is a radio wave, the electric field of which is horizontal to the traveling direction of the radio wave. Note that, in this specification, the radio wave of the vertically polarized wave means a radio wave in which a vertically polarized wave component is larger than a horizontally polarized wave component. The radio wave of the vertically polarized wave does not always have to be a radio wave including only the vertically polarized wave component. Similarly, the radio wave of the horizontally polarized wave means a radio wave in which a horizontally polarized wave component is larger than a vertically polarized wave component. The radio wave of the horizontally polarized wave does not always have to be a radio wave including only the horizontally polarized wave component.

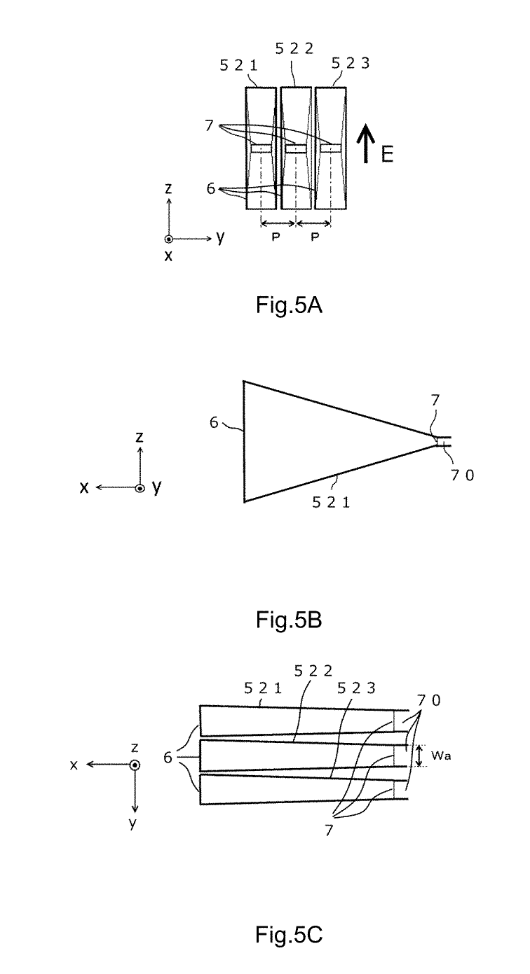

FIGS. 5A to 5C show the antenna 5 that uses the radio wave of the vertically polarized wave. For simplification, only the reception antenna 52 is shown. FIG. 5A shows the antenna 5 as viewed from the first direction. FIG. 5B is a sectional view of the antenna 5 as viewed from the second direction. FIG. 5C is a sectional view of the antenna 5 as viewed from the third direction. An arrow E indicates the direction of electric fields inside the horns. The reception horns are connected to an end portion of a rectangular waveguide 70 in the base 7. The other end portion of the rectangular waveguide 70 is connected to an MMIC (monolithic microwave integrated circuit) (not shown in the figure). The cross section of the rectangular waveguide 70 is rectangular. The width of a long side Wa needs to be λ/2 or more. The reception horns are disposed at the interval P in the second direction. When an azimuth angle range monitored by the vehicle-mounted radar 3 is represented as Ω and a wavelength of a radio wave in a free space is represented as λ, from Expression 5, the interval P needs to be less than λ/2·sin Ω. For example, when the azimuth angle range Ω is 50°, P needs to be less than 0.65λ. The antenna 5 is manufactured by casting of aluminum or the like. In the casting, thickness of at least approximately 0.5 mm needs to be secured among the reception horns taking into account fluidity of a melted material and a taper for die cutting. When the thickness among the reception horns is also taken into account, the manufacturing is difficult when the azimuth angle range is a wide angle such as 50°.

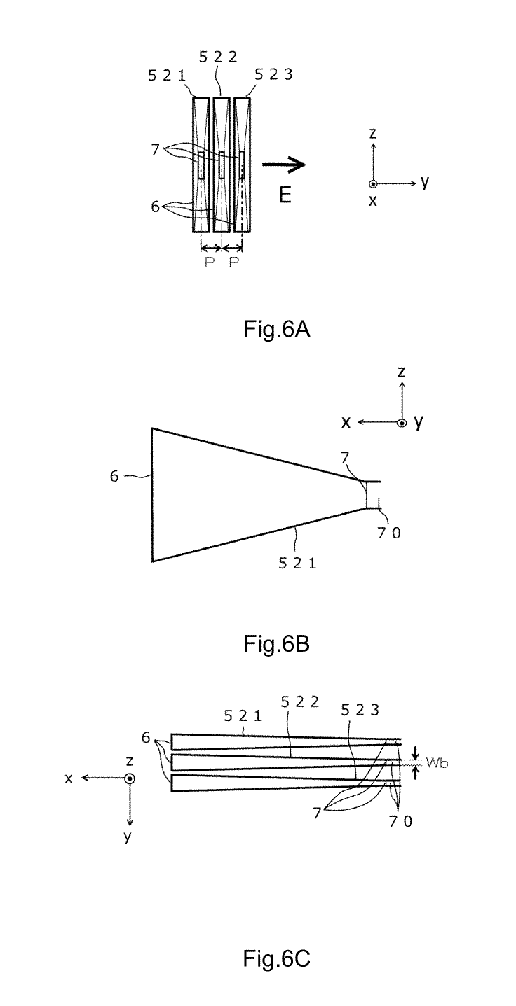

FIGS. 6A to 6C show the antenna 5 that uses a radio wave of the horizontally polarized wave. For simplification, only the reception antenna 52 is shown. FIG. 6A is the antenna 5 as viewed from the first direction. FIG. 6B is a sectional view of the antenna 5 as viewed from the second direction. FIG. 6C is a sectional view of the antenna 5 as viewed from the third direction. The arrow E indicates the direction of electric fields inside the horns. Explanation is omitted regarding portions having structures same as the structures in the antenna that uses the radio wave of the vertically polarized wave. When the radio wave of the horizontally polarized wave is used, there is no lower limit value in width Wb of the short side. Therefore, there is no limit in the interval P of the reception horns as well. That provides larger flexibility of design. Therefore, it is desirable to use the radio wave of the horizontally polarized wave when the azimuth angle range is the wide angle such as 50°.

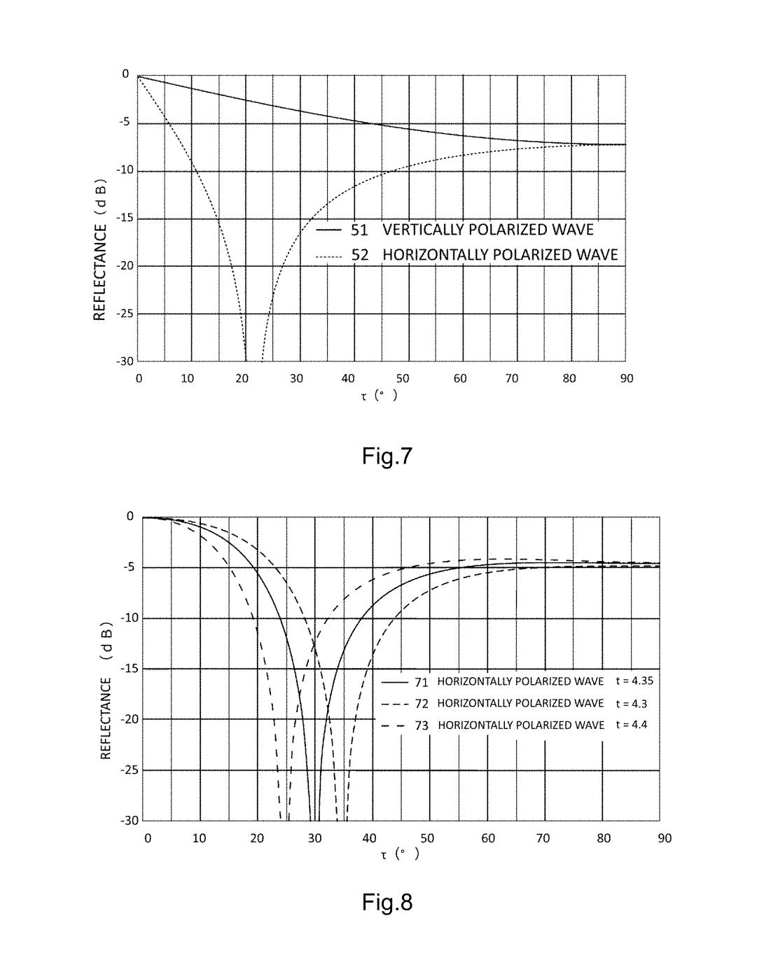

Reflectance at the time when the radio wave of the vertically polarized wave is used and reflectance at the time when the radio wave of the horizontally polarized wave is used are compared. A tilt angle with respect to the traveling direction (the first direction) of the radio wave of the windshield is represented as τ. FIG. 7 shows relations between the reflectance of the radio wave of the vertically polarized wave and the reflectance of the radio wave of the horizontally polarized wave and the tilt angle τ. A solid line 51 indicates the reflectance on the boundary surface 911 of the windshield 9 of the radio wave of the vertically polarized wave. A dotted line 52 indicates the reflectance on the boundary surface 911 of the windshield 9 of the radio wave of the horizontally polarized wave. A dielectric constant εr of the glass layer is 5 to 8. In this example, εr=6.5. A frequency is 76.5 GHz used in a millimeter wave radar. In any tilt angle, the reflectance of the radio wave of the vertically polarized wave is smaller than the reflectance of the radio wave of the horizontally polarized wave.

Therefore, when the radio wave of the horizontally polarized wave is used for the vehicle-mounted radar, there is not limit in design of the antenna and a reduction in size is possible. However, since the reflectance is large, the radio wave of the vertically polarized wave is often used in the past. In the present invention, since the radar window made of resin having the dielectric constant lower than the dielectric constant of the glass layer is used, it is possible to reduce the loss of the radar wave even when the radio wave of the horizontally polarized wave is used. Therefore, it is possible to reduce the loss of the radar wave while achieving a reduction in the size of the vehicle-mounted radar.

FIG. 8 shows relations between reflectances at the time when radio waves of horizontal polarized waves are used and the tilt angle τ in the present invention, where, t is a thickness of the radar window. A general resin material is used in the radar window 4. In this example, the dielectric constant εr is εr=4 and the wavelength λ is λ=3.92 mm at 76.5 GHz. When a reflected wave on the boundary surface 911 and a reflected wave on the boundary surface 921 have opposite phases, the reflected waves are offset and the reflectance is minimized. The thickness t of the radar window 4 at the time when the reflectance is minimized is represented by the following equation.

t=(m/2)·λ/√(εr−cos 2τ) (Expression 7)

where, m is a positive integer.

From Expression 7, the thickness t is selected with respect to the tilt angle τ of the windshield 2 (the tilt angle of the radar window 4). For example, when τ=30°, the thickness t is represented by a solid line 71 and t=4.35 mm is an optimum value. A broken line 72 and a chain line 73 indicate the cases of t=4.3, 4.4 mm, respectively and indicate characteristic changes within a standard manufacturing tolerance ±0.05 mm. Even if an error of the thickness t is the maximum during manufacturing, the reflectance is −12 dB or more (in terms of a reflectance loss, −0.3 dB or less). The reflected wave can be suppressed to be sufficiently small.

From FIG. 7, when the tilt angle t of the windshield 9 in the past is approximately 40° or more, even if the radio wave is the horizontally polarized wave, the reflectance is relatively small. Therefore, the radar window 4 of the present invention is more effectively used in a car model in which the tilt angle τ of the windshield is less than approximately 40°.

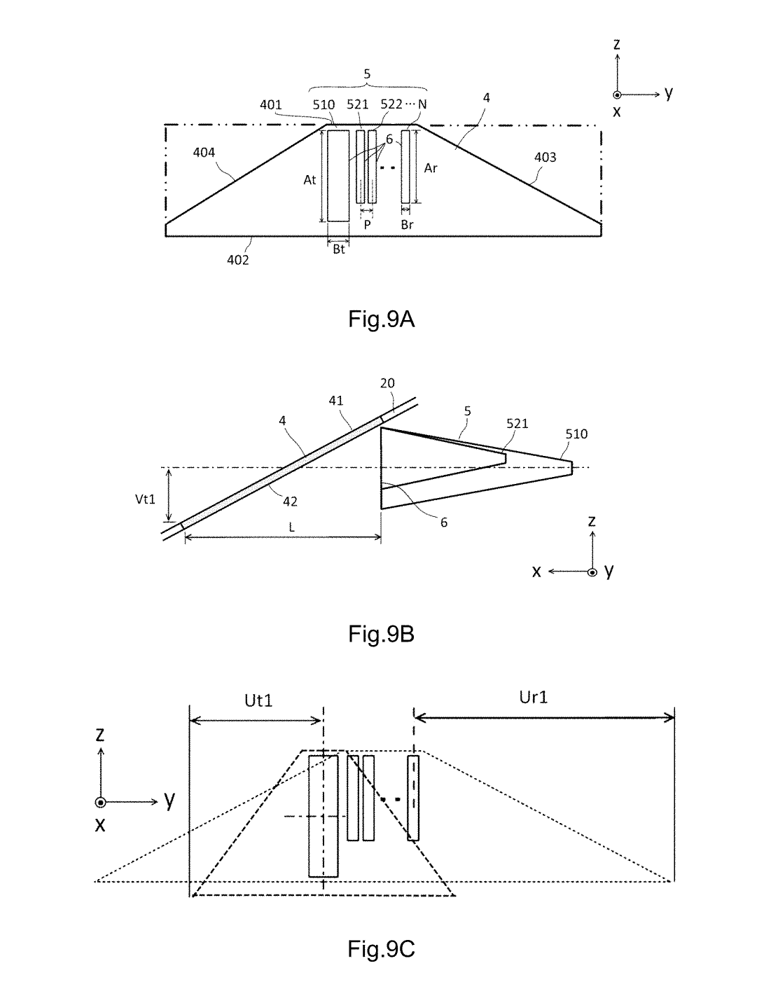

The dimensions of the antenna 5 and the radar window 4 are explained. FIG. 9A is a diagram of the windshield as viewed from the first direction. FIG. 9B is a sectional view of the windshield as viewed from the second direction. The antenna 5 includes one transmission horn 510 and a plurality of reception horns 521, 522, . . . , and N. The radar window 4 covers all of the aperture 6 of the horns. The radar window 4 includes a first edge 401 and a second edge 402 extending in the second direction and a third edge 403 and a fourth edge 404 that connect the first edge 401 and the second edge 402. The third edge 403 is located further on a positive side in the second direction than the fourth edge 404. The radar window 4 and the antenna 5 are disposed at an interval. However, the radar window 4 may be connected to the antenna 5.

When the azimuth angle range Ω to be monitored is Ω=50°, when the dimensions in the second direction (the lateral dimensions) of the transmission horn and the reception horns are respectively represented as Bt and Br, the interval P of the reception horns is set as P=2.2 mm and the dimensions are set as Bt=4.6 mm and Br=1.7 mm. The dimension Bt in the second direction of the transmission horn satisfies Bt<λ<sin Ω, which is a condition under which null is not caused within an azimuth angle.

An angle of depression of the distal end of a hood viewed from a room mirror position of a passenger car is generally approximately 15°. When dimensions in the third direction (the longitudinal dimensions) of the transmission horn and the reception horns are respectively represented as At and Ar, the dimensions are set as At=20 mm and Ar=14 mm such that the transmission horn and the reception horns do not block a field of view in this range.

In order to reduce the influence of a side lobe in an elevation angle range, null of the other of a transmission wave and a reception wave is adjusted to a peak of a side lobe of one of the transmission wave and the reception wave. In order to further reduce the side lobe, it is more desirable to set a ratio of the longitudinal dimension and the lateral dimension of the horns to 1:0.7.

A region of radiation from the transmission horn 510 is a far field if a distance L between the aperture 6 of the transmission horn 510 and the inner surface 42 of the radar window 4 is sufficiently large. When the distance between the aperture 6 of the transmission horn 510 and the inner surface 42 of the radar window 4 at this time is represented as Lf, Expression 8 holds.

Lf=20Bt2/λ (Expression 8)

In a region of L<Lf (a near field), a radiation field gradually expands further away from the opening.

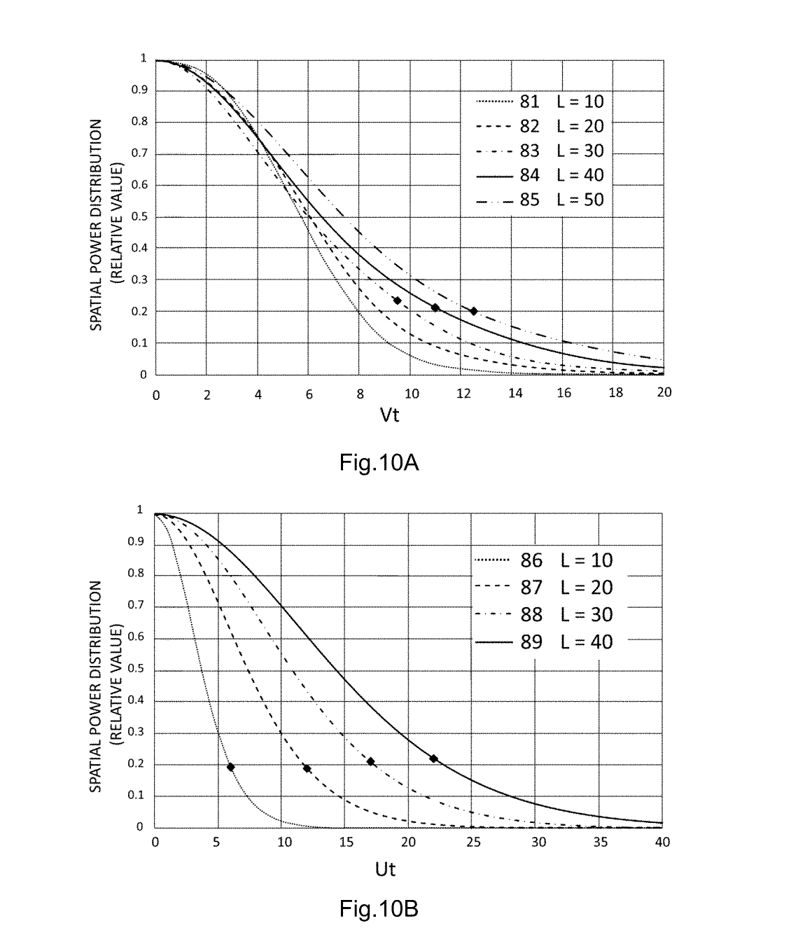

In FIGS. 10A and 10B, spatial power distributions of radiation fields in a second direction position Ut and a third direction position Vt are shown. Ut represents a second direction position from the center axis of the transmission horn 510. Vt represents a third direction position from the center axis. The spatial power distribution represents a relative value with respect to power density in the center.

For the transmission horn 510 (At=20 mm and Bt=4.6 mm), FIG. 10A shows a spatial power distribution in a plane (a YZ plane) formed by the second direction and the third direction including the radiation center axis in the third direction position Vt. A dotted line 81, a broken line 82, a chain line 83, a solid line 84, and a chain line 85 respectively indicate spatial power distributions at L=10, 20, 30, 40, and 50 mm. A third direction position Vt1 (the distance from the second edge 402 of the radar window 4 to the center of the transmission horn 510) for allowing a predetermined radio wave to pass is calculated according to L. It is assumed that required power is 95% (a blocking loss is 0.2 dB). In FIG. 10A, ♦ indicates a position where electric power further on the inner side than the position is 95%. When the tilt angle τ of the radar window 4 is τ=30°, the third direction position Vt1 is Vt1=10 mm and L is approximately 40 mm. Vt1 is set to, for example, 12 mm with a little margin. On the first edge 401 side of the radar window 4, as shown in FIG. 9B, the inner surface 42 of the radar window 4 is disposed as close as possible to the upper edge of the aperture 6 of the transmission horn 510. When viewed from the first direction, the radar window 4 is disposed to overlap the aperture 6 of the transmission horn 510.

FIG. 10B shows a spatial power distribution in a plane (an XY plane) formed by the first direction and the second direction including a radiation center axis in the second direction position Ut. A dotted line 86, a broken line 87, a chain line 88, and a solid line 89 respectively indicate spatial power distributions in the case of L=10, 20, 30, and 40 mm.

A second direction position Ut1 (the distance from the fourth edge 404 of the radar window 4 to the center of the transmission horn 510) for allowing a required radio wave to pass is calculated according to L. In FIG. 10B, ♦ indicates a position where electric power further on the inner side than the position is 95%. The second direction position Ut1 is calculated from the position. Ut1=22 mm when Vt1=12 mm (L≈40 mm).

The same analysis is applied to the reception horns 521, 522, . . . N (Ar=14 mm and Br=1.7 mm). A distance Vr1 from the second edge 402 of the radar window 4 to the center of the reception horn N and a distance Ur1 from the third edge 403 of the radar window 4 to the center of the reception horn N disposed at the most distant end from the third edge 403 of the radar window 4 are calculated. The distance Vr1 is calculated as Vr1=10 mm. When the lateral dimension Br of the reception horn N is substituted in Bt of Expression 8, L>15 mm, which means a far field. Therefore, it is necessary to provide the radar window 4 in a range of 50° from an aperture middle point of the horn. Therefore, Ur1=40 mm when Vr1=10 mm. Like Vt1, Ut1, Vr1, and Ur1 may be set to dimensions with margins given as appropriate.

In FIG. 9C, the radar window 4 having the dimension as viewed from the first direction is shown. A broken line indicates an external shape satisfying a dimension condition of an electric field of the transmission horn. A chain line indicates an external shape satisfying a dimension condition of an electric field of the reception horns. As an external shape satisfying both the conditions, for example, a shape obtained by combining a trapezoid and a square indicated by a thick line in FIG. 9A and a square shape indicated by a thick chain line in the figure are also selectable. In any way, the external shape of the radar window 4 only has to be an external shape satisfying both of the dimension condition of the electric field of the transmission horn and the dimension condition of the electric field of the reception horn.

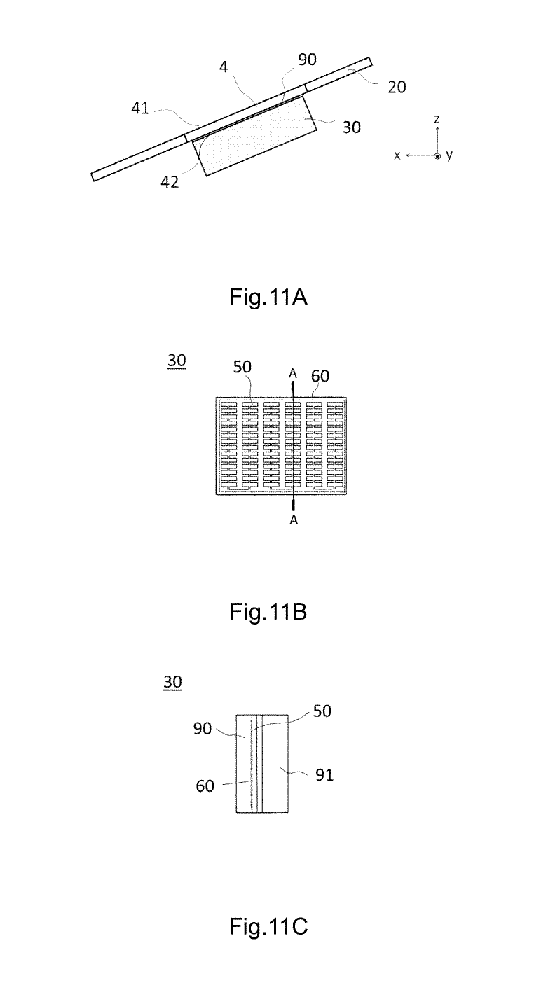

In FIGS. 11A and 11B, a modification of the present preferred embodiment is shown. FIG. 11A is a sectional view of a windshield of the modification of the present preferred embodiment as viewed from the second direction. FIG. 11B is a view of a vehicle-mounted radar shown in FIG. 11A as viewed from an aperture side of an antenna. FIG. 11C is a sectional view taken along A-A in FIG. 11B. The windshield in the modification is different from the windshield in the preferred embodiment in that an antenna 50 of a vehicle-mounted radar 30 is composed of patch antennas. The antenna 50 includes a transmission antenna and a reception antenna respectively composed of the patch antennas. A plurality of transmission antenna elements and a plurality of reception antenna elements configure an aperture 60 (a portion surrounded by a broken line) of the antenna 50. The vehicle-mounted radar includes a radome 90 that covers the aperture 60 side of the antenna 50 and a housing 91 that covers the opposite side of the aperture 60. In FIG. 11B, the radome 90 is omitted. The aperture 60 of the antenna 50 means a surface on which a radio wave is radiated. The aperture can rephrased as radiation surface. The aperture 60 of the antenna 50 is disposed along the inner surface 42 of the radar window 4. Therefore, the vehicle-mounted radar can be disposed in a space smaller than a space for the vehicle-mounted radar including the horn antenna. The radome 90 may be in contact with the inner surface 42 of the radar window 4. The antenna 50 and the radar window 4 are separate components. However, the antenna 50 may be connected to the radar window 4.

The radar window 4 may be a lens. When the radar window 4 is the lens, the antenna 5 and the radar window 4, which is the lens, function as a lens antenna together. The surface of the lens may have a curved shape or may be a flat shape. By using the lens antenna, it is possible to further reduce the reflection loss in the windshield. The entire radar window 4 may be a lens or a part of the radar window 4 may have a function of the lens.

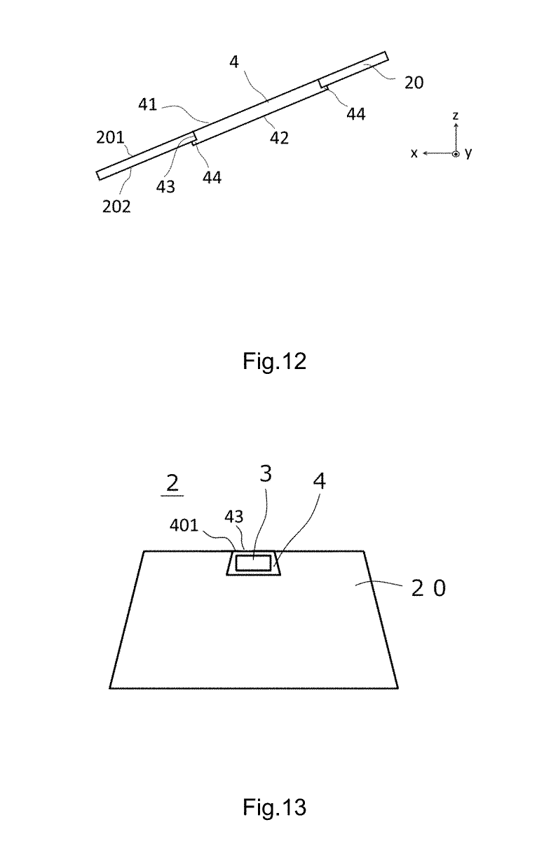

FIG. 12 shows a modification of the present preferred embodiment. The side surfaces 43 of the radar window 4 each includes a flange 44 expanding along the inner surface 202 of the windshield main body 20 on the inner surface 42 side of the radar window 4. The flange 44 adheres to the inner surface 202 of the windshield main body 20. The flange 44 may adhere via an adhesive or the like. The flange 44 does not have to be disposed over the entire side surface 43 of the radar window 4. The flange 44 may expand along the outer surface 201 of the windshield main body 20 on the outer surface 41 side of the radar window 4 and adhere to the outer surface 201 of the windshield main body 20.

With this structure, it is possible to more firmly fix the radar window 4 and the windshield main body 20.

FIG. 13 shows a modification of the present preferred embodiment. The side surface 43 on the first edge 401 side of the radar window 4 is not in contact with the windshield main body 20. The side surface 43 on the first edge 401 side is directly fixed to a vehicle body.

The present invention can be rephrased as an invention of a radar system that detects an object around the radar system with transmitted and received radio waves in the millimeter band. The radar system includes the windshield 2. The windshield 2 includes the windshield main body 20 and the radar window 4. The structures of the windshield main body 20 and the radar window 4 are the same as the structures in the present preferred embodiment.

The vehicle 1 is not limited to the passenger car and may be vehicles for various uses such as a truck and a train. Further, the vehicle 1 is not limited to a vehicle for manned driving and may be an unmanned driving vehicle such as an unmanned guided vehicle in a factory.

The configurations in the preferred embodiment and the modifications may be combined as appropriate as long as the configurations are not contradictory to one another.

The vehicle and the radar system according to the present invention can be used for various uses.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A windshield comprising:
a vehicle-mounted radar that detects an object around the vehicle-mounted radar with transmitted and received radio waves in a millimeter band;
a radar window on which at least a portion of the radio waves is incident; and
a windshield main body including a single glass layer or at least one glass layer on which a resin layer is laminated; wherein
both of the windshield main body and the radar window are plate-shaped;
an area of the radar window is smaller than an area of the windshield main body;
a dielectric constant of the radar window is smaller than a dielectric constant of the glass layer; and
at least a portion of a side surface connecting an outer surface and an inner surface of the radar window is in contact with a side surface connecting an outer surface and an inner surface of the windshield main body.

2. The windshield according to claim 1, wherein the outer surface of the radar window and the outer surface of the windshield main body define a single continuous surface.

3. The windshield according to claim 1, wherein
the windshield main body includes upper and lower edges extending in a lateral direction and left and right edges extending in an up-down direction and the lower edge is longer than the upper edge; and
the radar window increases in width toward the lower edge from the upper edge of the windshield main body.

4. The windshield according to claim 2, wherein
the windshield main body includes an upper edge and a lower edge both extending in a lateral direction and a left edge and a right edge both extending in an up-down direction and lower sides of the upper edge and the lower edge are longer than upper sides of the upper edge and the lower edge; and
the radar window increases in width toward the lower edge from the upper edge of the windshield main body.

5. The windshield according to claim 1, wherein
the side surface of the radar window includes a flange expanding along the outer surface or the inner surface of the windshield main body on an outer surface side or an inner surface side of the radar window; and
the flange adheres to the outer surface or the inner surface of the windshield main body.

6. The windshield according to claim 2, wherein
the side surface of the radar window includes a flange expanding along the outer surface or the inner surface of the windshield main body on an outer surface side or an inner surface side of the radar window; and
the flange adheres to the outer surface or the inner surface of the windshield main body.

7. The windshield according to claim 3, wherein
the side surface of the radar window includes a flange expanding along the outer surface or the inner surface of the windshield main body on an outer surface side or an inner surface side of the radar window; and
the flange adheres to the outer surface or the inner surface of the windshield main body.

8. The windshield according to claim 4, wherein
the side surface of the radar window includes a flange expanding along the outer surface or the inner surface of the windshield main body on an outer surface side or an inner surface side of the radar window; and
the flange adheres to the outer surface or the inner surface of the windshield main body.

9. A radar system that detects an object around the radar system with transmitted and received radio waves in a millimeter band, the radar system comprising:
a vehicle-mounted radar; and
a windshield disposed on a side where the radio waves are radiated by the radar; wherein
the windshield includes a windshield main body including a single glass layer or at least one glass layer on which a resin layer is laminated;
the windshield includes a radar window on which at least a portion of the radio waves is incident;
both of the windshield main body and the radar window are plate-shaped;
an area of the radar window is smaller than an area of the windshield main body;
a dielectric constant of the radar window is smaller than a dielectric constant of the glass layer; and
at least a portion of a side surface connecting an outer surface and an inner surface of the radar window is in contact with a side surface connecting an outer surface and an inner surface of the windshield main body.

10. The radar system according to claim 9, wherein
the vehicle-mounted radar includes an antenna that transmits and receives the radio waves; and
at least a portion of the radar window is connected to the antenna.

11. The radar system according to claim 10, wherein a lower edge of an aperture of the antenna is located farther on a lower side than the inner surface of the windshield main body.

12. The radar system according to claim 10, wherein an aperture surface of the antenna expands along the inner surface of the windshield main body.

13. The radar system according to claim 9, wherein a vertically polarized wave component is smaller than a horizontally polarized wave component in the radio waves.

14. The radar system according to claim 10, wherein a vertically polarized wave component is smaller than a horizontally polarized wave component in the radio waves.

15. The radar system according to claim 11, wherein a vertically polarized wave component is smaller than a horizontally polarized wave component in the radio waves.

16. The radar system according to claim 12, wherein a vertically polarized wave component is smaller than a horizontally polarized wave component in the radio waves.

17. The radar system according to claim 9, wherein the side surface of the radar window includes a flange expanding along the outer surface or the inner surface of the windshield main body on an outer surface side or an inner surface side of the radar window; and
the flange adheres to the outer surface or the inner surface of the windshield main body.

18. A vehicle mounted with the radar system according to claim 9, wherein
the vehicle includes a rear view mirror in a vehicle interior; and
the vehicle-mounted radar is disposed between the radar window and the rear view mirror.

19. The vehicle according to claim 9, wherein an angle defined by the windshield and a traveling direction of the radio waves is less than 40°.
